(19) United States
(12) Patent Application Publication
(10) Pub. No.: US 2013/0071515 A1
(43) Pub. Date: Mar. 21, 2013

(54) NON-TACK GUM BASE, CHEWING GUM PREPARATION PRODUCED THEREFROM AND METHODS FOR PRODUCTION THEREOF

(71) Applicants: Thomas WIMMER, Burghausen (DE); Sabine GRUBER, Tittmoning (DE)

(72) Inventors: Thomas WIMMER, Burghausen (DE); Sabine GRUBER, Tittmoning (DE)

(73) Assignee: WACKER CHEMIE AG, Muenchen (DE)

(21) Appl. No.: 13/591,936

(22) Filed: Aug. 22, 2012

(30) Foreign Application Priority Data
Sep. 19, 2011 (DE) 10 2011 082 981.4

(51) Int. Cl. A23G 4/08

(52) U.S. Cl. 426/4

(57) ABSTRACT

The invention relates to a non-tack gum base, a chewing gum preparation produced therefrom and also methods for production thereof. It is a homogeneous composition comprising polyvinyl acetate in an amount of 25-90% by weight, vinyl laurate-vinyl acetate copolymer in an amount of 5-70% by weight, and a softener in an amount of 1%-15% by weight, in each case based on the total weight of the composition.

### BACKGROUND OF THE INVENTION

The invention relates to a non-tack gum base, a chewing gum preparation produced therefrom and also methods for production thereof.

Chewing gum preparations usually comprise a water-insoluble part, termed the gum base, and a water-soluble part (sugar or polyols/sugar alcohols), which in a lesser amount contains flavorings, sweeteners and optionally dyes or antioxidants.

Typically, gum base formulations contain elastomers (such as, e.g., polyisobutylene, butyl rubber, styrene-butadiene rubber or natural rubber), polyvinyl acetate, polyterpenes or rosin esters, fillers, softeners, fats (in part hardened vegetable fats) or waxes (paraffin waxes, microcrystalline waxes) and emulsifiers and softeners.

U.S. Pat. No. 5,116,626 describes a transparent gum base/chewing gum preparation comprising virtually exclusively polyvinyl acetate, polyisobutylene, vinyl laurate-vinyl acetate copolymers and a softener.

A non-tack chewing gum which is characterized by omission of polyterpenes in the gum base, is described in U.S. Pat. No. 5,538,741.

### DESCRIPTION OF THE INVENTION

It is the object of the present invention to provide a gum base and, based on this gum base, a chewing gum preparation that is less tacky than known gum bases/chewing gum preparations.

The former object is achieved by a homogeneous composition comprising polyvinyl acetate in an amount of 25-90% by weight, vinyl laurate-vinyl acetate copolymer in an amount of 5-70% by weight, and a softener in an amount of 1%-15% by weight, in each case based on the total weight of the composition.

Preferably, the homogeneous composition is 30-70% by weight, particularly preferably 43-60% by weight, composed of polyvinyl acetate (PVAc) and 20-50% by weight, particularly preferably 30-45% by weight, composed of vinyl laurate-vinyl acetate copolymer (VL/VA copolymer). The softener is preferably present in an amount of 5-13% by weight.

All % by weight data are based on the total weight of the respective composition. The amounts of the constituents used specified in % by weight of a formula in each case total 100% by weight.

Preference is given to polyvinyl acetates having a weight-average molecular weight Mw from 10 000 to 60 000, particularly preferably 15 000 to 50 000. The weight-average molecular weight Mw is determined by size exclusion chromatography (SEC) against a polystyrene standard in THF at 40° C., flow rate 1.2 ml/min. Mixtures of polyvinyl acetates having variable molecular weight can also be used.

The vinyl laurate-vinyl acetate copolymer preferably has a weight-average molecular weight Mw from 100 000 to 600 000, particularly preferably 150 000 to 400 000. The vinyl laurate-vinyl acetate copolymer preferably contains 15 to 60% by weight vinyl laurate units and 40 to 85% by weight vinyl acetate units, particularly preferably 35-45% by weight vinyl laurate units and 55 to 65% by weight vinyl acetate units. A plurality of vinyl laurate-vinyl acetate copolymers having differing copolymer composition and/or differing molecular weight can also be used.

The softener is preferably selected from the group consisting of diacetin, triacetin, acetem, glycerol monostearate. As softener, preference is given to triacetin or acetem, particular preference to triacetin.

The homogeneous composition according to the invention is suitable preferably as gum base, and the invention therefore also relates to the use of a composition according to the invention as gum base. This gum base and also a chewing gum produced therefrom are less tacky, e.g. to textiles and “urban” surfaces such as asphalt or concrete. In addition, the gum base according to the invention is readily soluble in a physiologically harmless solvent such as, e.g., ethanol, which facilitates cleaning of chewing gum-soiled textiles or other surfaces. In addition, the gum base according to the invention and also chewing gum preparations produced therefrom exhibit an improved release of flavorings than known gum bases/chewing gum preparations.

The gum base according to the invention can be produced by a method usual for such masses, generally a kneading method. The production can proceed continuously, e.g. in an extruder, or batchwise, e.g. in a double-Z kneader. It preferably proceeds at a temperature of 80-130° C., preferably 90-120° C., over a period of 30 to 100 minutes.

Polyvinyl acetates and vinyl laurate-vinyl acetate copolymers suitable for this purpose are commercially available, for example the VINNAPAS® solid resins from Wacker Chemie AG. The polyvinyl acetate component and the vinyl laurate-vinyl acetate copolymer components can be produced in a known manner by mass or solution polymerization. A suitable method is described, for example, in EP 1352914 B1. For this purpose, the corresponding monomers are polymerized in the presence of initiators such as peroxide or azo initiators, optionally in a usually alcoholic solvent and optionally in the presence of chain-transfer agents, at a temperature of generally 40° C. to 140° C., and solvent and chain-transfer agent and also residual monomer are optionally distilled off.

The gum base according to the invention can be produced directly from the 3 components. Alternatively, it can be produced by producing a liquid and solid preblend and subsequently mixing these preblends, preferably in the weight ratio liquid:solid preblend=1:5.5. The liquid preblend comprises the VL/VA copolymer and the softener in the weight ratio 1:2 to 2:1. It is produced by mixing the two components in said mixing ratio. The solid preblend comprises PVAc and VL/VA copolymer. It can be produced by mixing the melts of polyvinyl acetate and the vinyl acetate-vinyl laurate copolymer at 80-140° C. Alternatively, the solid preblend can be produced by 2-stage solution polymerization. Production and possible composition thereof are described in U.S. 2008241314 A2, to which details therein reference is made in this respect.

Production of the gum base using a liquid preblend makes possible easier handling and easier metering of the copolymer and is therefore preferred.

The production of a chewing gum according to the invention from the gum base usually proceeds at approximately 60° C. with addition of sugar, syrup, flavorings and optionally dyes, fruit acids, sweeteners, humectants. Sugarless chewing gum is produced similarly from gum base, polyols (sugar alcohol, also termed bulk sweetener), flavorings, sweeteners and optionally dyes, fruit acids, humectants. The addition proceeds in amounts such as are obtained in the composition specified hereinafter.

The gum base according to the invention is optionally heated to 40-60° C. and mixed with the other chewing gum ingredients at 45-65° C. to form a dough. This can proceed, for example, in a heatable double-Z kneader or in an extruder. Then, the chewing gum mass is shaped by usual methods. Continuous methods known to those skilled in the art serve for shaping, such as extrusion, co-extrusion, rolling or cutting. Possible shapes which come into consideration are strips, slabs, pellets, webs or hollow spheres.

The resultant chewing gum according to the invention comprises 13-35% by weight of gum base according to the invention, 62-85% by weight of one or more polyols in solid form or as highly-concentrated syrup and 1-3% by weight of usual flavorings, and optionally up to 3% humectant (e.g. glycerol), optionally fruit acids (e.g. citric acid, malic acid, tartaric acid) up to 1.5% by weight and optionally sweeteners (acesulfame, aspartame, aspartame-acesulfame salt, cyclamate, saccharine, sucralose, thaumatin, neohesperidin, neotame, stevioside) up to 0.5% by weight.

The polyols are preferably sorbitol, mannitol, maltitol, isomalt, xylitol, erythritol or a mixture thereof.

The examples hereinafter serve for further illustration of the invention:

### Example 1

### Production of a Gum Base

In a heatable double-Z kneader, 550 g of homopolymeric PVAc (commercially available from Wacker Chemie AG under the name VINNAPAS B 1.5 sp; Mw 15 000) were melted at 120° C. together with 380 g of vinyl acetate-vinyl laurate copolymer (monomer ratio by weight: 60:40; commercially available from Wacker Chemie AG under the name VINNAPAS B 500/40 VL) and mixed with 70 g of triacetin. The mixture was withdrawn from the kneader and allowed to cool to room temperature.

### Example 2

### Production of a Gum Base

In a heatable double-Z kneader, 450 g of homopolymeric PVAc (commercially available from Wacker Chemie AG under the name VINNAPAS B 30 sp; Mw 50 000) were melted at 125° C. together with 470 g of vinyl acetate-vinyl laurate copolymer (monomer ratio by weight: 60:40; commercially available from Wacker Chemie AG under the name VINNAPAS B 500/40 VL) and mixed with 80 g of triacetin. The mixture was withdrawn from the kneader and allowed to cool to room temperature.

### Example 3

### Production of a Gum Base

In a heatable double-Z kneader, 560 g of homopolymeric PVAc (commercially available from Wacker Chemie AG under the name VINNAPAS B 5 sp; Mw 25 000) were melted at 110° C. together with 370 g of vinyl acetate-vinyl laurate copolymer (monomer ratio by weight: 60:40; commercially available from Wacker Chemie AG under the name VINNAPAS B 500/40 VL) and mixed with 70 g of triacetin. The mixture was withdrawn from the kneader and allowed to cool to room temperature.

### Example 4

### Production of a Gum Base

In a heatable double-Z kneader, 460 g of homopolymeric PVAc (VINNAPAS B 17 sp; Mw 40 000) are melted at 125° C. together with 450 g of vinyl acetate-vinyl laurate copolymer (monomer ratio by weight: 60:40; VINNAPAS B 500/40 VL) and mixed with 90 g of triacetin. The mixture is withdrawn from the kneader and allowed to cool to room temperature.

### Example 5

### Production of a Gum Base

In a heatable double-Z kneader, 430 g of homopolymeric PVAc (commercially available from Wacker Chemie AG under the name VINNAPAS B 1.5 p; Mw 15 000) were melted at 125° C. together with 450 g of vinyl acetate-vinyl laurate copolymer (monomer ratio by weight: 80:20; commercially available from Wacker Chemie AG under the name VINNAPAS B 500/20 VL) and mixed with 120 g of acetic acid esters of monoglycerides commercially available from DANISCO under the name Grinsted©Acetem. The mixture was withdrawn from the kneader and allowed to cool to room temperature.

### Example 6

### Production of a Gum Base

In a heatable double-Z kneader, 500 g of homopolymeric PVAc (commercially available from Wacker Chemie AG under the name VINNAPAS B 1.5 p; Mw 15 000) were melted at 120° C. together with 400 g of vinyl acetate-vinyl laurate copolymer (monomer ratio by weight: 60:40; commercially obtainable from Wacker Chemie AG under the name VINNAPAS B 500/40 VL) and mixed with 100 g of glycerol monostearate. The mixture is withdrawn from the kneader and allowed to cool to room temperature.

### Example 7

### Production of a Mixture of VA/VL Copolymer+Triacetin (Liquid Preblend)

500 g of vinyl acetate-vinyl laurate copolymer (monomer ratio by weight: 60:40; commercially obtainable from Wacker Chemie AG under the name VINNAPAS B 500/40 VL) were melted in a double-Z kneader at 110° C. and, after addition of 500 g of triacetin, the mixture was kneaded for approximately 30 minutes at approximately 100° C. The preblend was cooled and is liquid at room temperature.

### Example 8

### Production of a Gum Base from the Preblend According to Example 7

In a heatable double-Z kneader, 850 g of a compound of PVAc+VA/VL copolymer (described in example 1 of the laid-open application DE 10 2007 015 941 A1) were homogenized with 150 g of the preblend from example 7 at 120° C. The mixture was withdrawn from the kneader and allowed to cool to room temperature.

### Example 9

### Production of a Sugarless Chewing Gum

In a heatable double-Z kneader, a chewing gum mass was produced at 60-80° C. from the ingredients in Tab. 1.

TABLE 1

| | | |
|---|---|---|
| Gum base of example 1 | 320 | g |
| Sorbitol | 435 | g |
| Lycasin (maltitol syrup) | 63 | g |
| Xylitol | 160 | g |
| Aspartame | 2 | g |
| Peppermint oil | 15 | g |
| Glycerol | 5 | g |

### Example 10

### Production of a Gum Base—Comparison 1 (as per U.S. Pat. No. 5,116,626, Example Table 1, Column “D”)

150 g of polyisobutylene (commercially available from BASF under the name Oppanol B 12 SFN) were mixed in a double-Z kneader at 120° C. with 700 g of homopolymeric PVAc, medium molecular weight (commercially available from Wacker Chemie AG under the name VINNAPAS B 17 p; Mw 40 000), 100 g of triacetin and 50 g of hydrogenated vegetable fat for approximately 2 hours. The kneader was emptied and the mass was allowed to cool to room temperature.

### Example 11

### Production of a Gum Base—Comparison 2 (as per U.S. Pat. No. 5,116,626, Claim 1)

150 g of polyisobutylene (commercially available from BASF under the name Oppanol B 12 SFN) were mixed for approximately 2 hours in a double-Z kneader at 120° C. with 650 g of homopolymeric PVAc, low molecular weight (commercially available from Wacker Chemie AG under the name VINNAPAS B 1.5 p; Mw 15 000), 100 g of triacetin and 100 g of vinyl acetate-vinyl laurate copolymer (monomer ratio by weight: 60:40; commercially available from Wacker Chemie AG under the name VINNAPAS B 500/40 VL). The kneader was emptied and the mass was allowed to cool to room temperature.

### Example 12

### Production of Chewing Gum from the Gum Base According to the Invention (Example 3) and Comparative Mass from Example 10 and 11.

From the ingredients mentioned in table 2 (all data in % by weight), a chewing gum mass was produced at 60° C. in a double-Z kneader in the course of 30 minutes. The chewing gum mass was rolled to a layer thickness of approximately 2 mm and cut into strips having a weight of approximately 1.5 grams.

TABLE 2

| | Chewing gum A | | |
|---|---|---|---|
| | (according to | Chewing gum B | Chewing gum C |
| | the invention) | (comparison 1) | (comparison 2) |
| Gum base example 3 | 32.0 | — | — |
| Gum base example 10 | — | 32.0 | — |
| Gum base example 11 | — | — | 32.0 |
| Sorbitol | 40.9 | 40.9 | 40.9 |
| Lycasin-maltitol syrup | 9.0 | 9.0 | 9.0 |
| Xylitol | 13.6 | 13.6 | 13.6 |
| Aspartame | 0.1 | 0.1 | 0.1 |
| Sucralose | 0.05 | 0.05 | 0.05 |
| Glycerol | 1.0 | 1.0 | 1.0 |
| Peppermint aroma | 1.0 | 1.0 | 1.0 |
| Cherry aroma | 1.5 | 1.5 | 1.5 |
| Citric acid | 0.8 | 0.8 | 0.8 |

### Example 13

### Comparison Test of Tackiness of Chewing Gums A, B and C to Concrete

The concrete blocks (25 cm×20 cm×10 cm) used for testing were washed using a high-pressure cleaner for approximately 2-3 minutes and then dried. The chewing gums (A, B, C) were each chewed for 20 minutes and the chewed chewing gum, which predominantly comprises gum base, was placed in the center of a concrete block. The chewing gum is covered with a siliconized paper. Then, the silicone paper with the chewing gum beneath is loaded by one person for approximately 2 seconds. The silicone paper is taken off and the concrete block with the chewing gum is stored for 4 weeks at room temperature.

The concrete block, after the storage time, is cleaned using a high-pressure cleaner for 60 seconds in each case. In both comparative examples, residues (approximately 5-10% of the original amount) of chewing gum were observed on the concrete surface, whereas the chewing gum according to the invention could be removed completely.

What is claimed is:

1. A homogeneous composition comprising polyvinyl acetate in an amount of 25-90% by weight, vinyl laurate-vinyl acetate copolymer in an amount of 5-70% by weight, and a softener in an amount of 1%-15% by weight, wherein percentages by weight are based on a total weight of the composition.

2. The homogeneous composition as claimed in claim 1, wherein the polyvinyl acetate constitutes 30-70% by weight of the composition, the vinyl laurate-vinyl acetate copolymer constitutes 20-50% by weight of the composition, and the softener constitutes 5-13% by weight of the composition.

3. The homogeneous composition as claimed in claim 1, wherein the polyvinyl acetate constitutes 43-60% by weight of the composition, the vinyl laurate-vinyl acetate copolymer constitutes 30-45% by weight of the composition, and the softener constitutes 5-13% by weight of the composition.

4. The homogeneous composition as claimed in claim 1, wherein the polyvinyl acetate has a weight-average molecular weight Mw from 10,000 to 60,000, and the vinyl acetate-vinyl laurate copolymer has a weight-average molecular weight Mw from 100,000 to 600,000.

5. The homogeneous composition as claimed in claim 1, wherein the softener is a member selected from the group consisting of diacetin, triacetin, acetem and glycerol monostearate.

6. A method for producing a homogeneous composition as claimed in claim 1, said method comprising mixing together the polyvinyl acetate, vinyl acetate-vinyl laurate copolymer and softener in a batch or continuous method at a temperature of 80-130° C. over a period of 30 to 100 minutes.

7. A method for producing a homogeneous composition as claimed in claim 1, said method comprising:
producing a liquid preblend comprising a vinyl acetate-vinyl laurate copolymer and a softener in a weight ratio of 1:2 to 2:1,
producing a solid preblend comprising polyvinyl acetate and vinyl acetate-vinyl laurate copolymer; and
mixing the liquid preblend and the solid preblend in a batch or continuous method at a temperature of 80-130° C. over a period of 30 to 100 min.

8. A chewing gum comprising a composition as claimed in claim 1 and either: (a) sugar, syrup, flavorings and optionally dyes, fruit acids, sweeteners and humectants; or (b) polyols, flavorings, sweeteners and optionally dyes, fruit acids and humectants.

9. A chewing gum, wherein the composition of claim 1 constitutes 13-35% by weight of the gum, polyols constitute 62-85% by weight of the gum, flavorings constitute 1-3% by weight of the gum, humectant constitutes 0-3% by weight of the gum, fruit acids constitute 0-1.5% by weight of the gum and sweeteners constitute 0-0.5% by weight of the gum.

10. A method for producing a chewing gum as claimed in claim 8, said method comprising mixing at approximately 60° C. a homogeneous composition as claimed in claim 1 with polyols or sugar and syrup and flavorings and optionally dyes, fruit acids, sweeteners.

11. A method of using the composition as claimed in claim 1 as gum base.
